(19) United States
(12) Patent Application Publication
(10) Pub. No.: US 2017/0146955 A1
(43) Pub. Date: May 25, 2017

(54) TIMEPIECE COMPONENT WITH IMPROVED TRIBOLOGY

(71) Applicant: Nivarox-FAR S.A., Le Locle (CH)

(72) Inventors: Christian CHARBON, Chezard-St-Martin (CH); Philippe DUBOIS, Marin (CH)

(73) Assignee: Nivarox-FAR S.A., Le Locle (CH)

(21) Appl. No.: 15/337,060

(22) Filed: Oct. 28, 2016

(30) Foreign Application Priority Data
Nov. 19, 2015 (EP) 15195386.6

(51) Int. Cl. G04B 31/08; G04B 15/14

(52) U.S. Cl. CPC G04B 31/08; G04B 15/14

(57) ABSTRACT

A timepiece component comprising a dry, self-lubricating surface layer, consisting entirely of boric acid, having a thickness of 50 nanometres to 1 micrometre. A method for coating a timepiece component with a self-lubricating surface layer, including dissolving, at ambient temperature, boric acid H₃BO₃ granules or powder in a solvent chosen from among water, isopropanol, propanol, methanol, methyl propanol, glycol ethylene, glycerol, acetone, in a proportion of 0.01% to 1.0% by mass; mixing and agitating the solution; dipping the component to be coated in this solution; removing the component from the solution and allowing the liquid phase to evaporate, with the surface forming the surface layer kept away from any foreign bodies, until evaporation is complete; and repeating the dipping and evaporation steps until the desired layer thickness is obtained, from 10 nanometres to 1 micrometer, or more particularly from 50 nanometres to 1 micrometre.

This application claims priority from European Patent application 15195386.6 of Nov. 19, 2015, the entire disclosure of which is hereby incorporated herein by reference.

### FIELD OF THE INVENTION

The invention concerns a timepiece component comprising at least one self-lubricating surface layer.

The invention also concerns a timepiece escapement mechanism comprising at least one such component.

The invention also concerns a timepiece movement including at least one such escapement mechanism.

The invention also concerns a watch comprising at least one movement.

The invention also concerns a method for coating a timepiece component with a self-lubricating surface layer.

The invention concerns the field of components for timepiece mechanisms subjected to intense usage, with a high impulse frequency, and a high number of impulses and friction phases during operation, such as the components of escapement mechanisms.

### BACKGROUND OF THE INVENTION

The maintenance-free operation of an escapement mechanism, in particular the Swiss lever escapement which is the most common, remains a major objective of current watchmaking developments. Since maintenance generally means replenishing the lubrication, the development of non-lubricated escapements involves the search for solid materials exhibiting exceptional tribological properties. Further, the current trend of making escapements operate at higher frequency, in order to increase accuracy, is limited by oils that tend to be ejected when they are subjected to high accelerations. Currently, there is a particularly pronounced demand for dry lubrication.

GB Patent Application 528370A in the name of CHRYSLER CORPORATION discloses compressed and sintered, porous, metallic powder-based compositions, able to be made self-lubricating by hot dipping in an oil bath or by the introduction of a suitable solid lubricant into its pores. It describes the use of plates thereby produced for creating timepiece structures with integrated bearings. These plates may be reinforced by other metal plates. Particular compositions of dry self lubricating surface layers concern mixtures in suitable percentages of:
lead, tin, graphite, boric acid,
copper, tin, mica, boric acid,
iron, copper, graphite, boric acid,
   these mixtures being compressed into briquettes in dies or rollers, and sintered, preferably in a reducing atmosphere.

US Patent Application 2159327A in the name of HENDRICK JOHN, CHRYSLER CORPORATIO discloses a bearing assembly comprising, between, on the one hand, a pivot made of porous metal that has absorbed a liquid lubricant, and on the other hand, a sleeve able to lose its elasticity and made of a non-metallic material covering the pivot, with an intermediate sleeve comprising a material impermeable to lubricants. In a particular composition, the porous metal comprises copper, tin and graphite, and may contain a solid lubricant such as boric acid or salicylic acid, useful in particular, during pressing or sintering.

An article by BARTHEL ANTHONY J ET AL, “Origin of Ultra-Low Friction of Boric Acid: Role of Vapor Adsorption”, Tribology Letters, Baltzer Science Publishers, NL, Vol. 58, N° 3, 21 Apr. 2015, pages 1-12, XP035489852, ISSN 1023-8883, describes the lubricating properties of boric acid.

### SUMMARY OF THE INVENTION

Boric acid H₃BO₃ has a particular advantage in terms of friction, due to its dry lubrication ability. During friction, the flat crystal links of boric acid tend to organise themselves into layers parallel to the surface. This arrangement reduces friction in a similar manner to better-known compounds, such as molybdenum sulphide MoS₂ and tungsten sulphide WS₂.

It is an object of the invention to achieve non-lubricated operation of the timepiece escapement, in order to reduce maintenance, and to allow for high oscillation frequencies.

To this end, the invention concerns a timepiece component comprising at least one self-lubricating surface layer according to claim 1.

The invention also concerns a timepiece escapement mechanism comprising at least one such component.

The invention also concerns a timepiece movement including at least one such escapement mechanism.

The invention also concerns a watch comprising at least one movement.

The invention also concerns a method for coating a timepiece component with a self-lubricating surface layer, according to claim 12.

### BRIEF DESCRIPTION OF THE DRAWINGS

Other features and advantages of the invention will appear upon reading the following detailed description, with reference to the annexed drawings, in which:

FIG. 1 shows a schematic and perspective view of the triclinic crystal structure of boric acid H₃BO₃, in strata substantially parallel to each other and to the surface of the material;

FIG. 2 is a block diagram representing a watch, which comprises a movement in turn comprising an escapement mechanism with a component according to the invention.

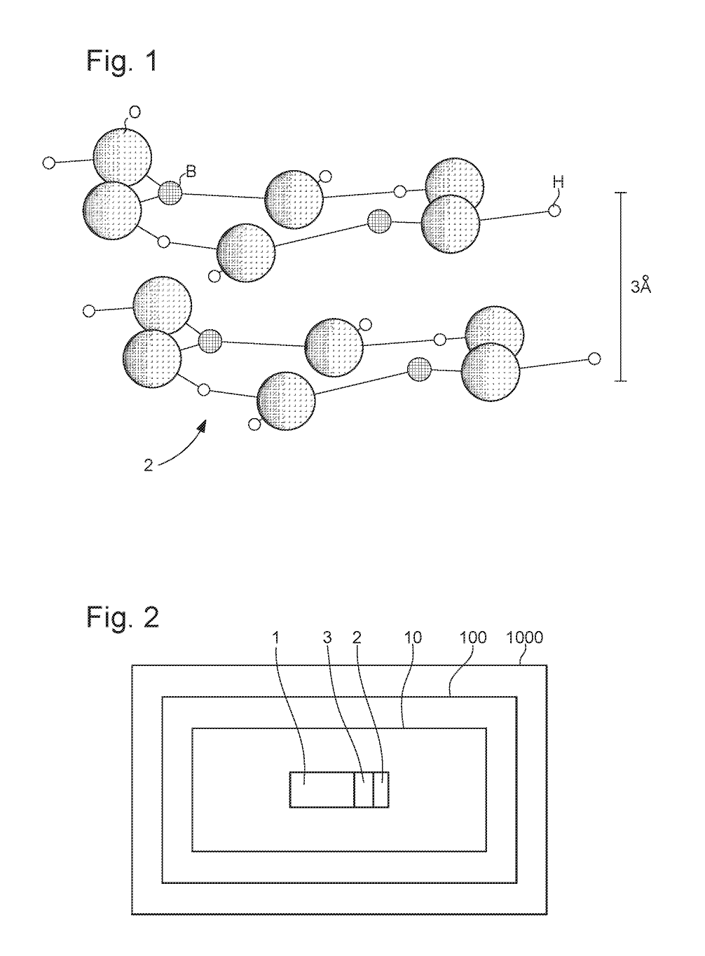

### DETAILED DESCRIPTION OF PREFERRED EMBODIMENTS

The present invention proposes, at least for the components of timepiece mechanisms, undergoing the most stress, to produce them with a dry, self-lubricating surface layer, for which the use of boric acid H₃BO₃ is preferred, which has a particular advantage in terms of friction, due to its dry lubrication ability.

Thus, the invention concerns a timepiece component 1 comprising at least one self-lubricating surface layer 2. According to the invention, this surface layer 2 is a dry layer comprising boric acid H₃BO₃ and has a thickness comprised between 10 nanometres and 10 micrometres.

More particularly, this thickness is comprised between 50 nanometres and 1 micrometre.

More particularly, according to the invention, this surface layer 2 consists entirely of boric acid.

Advantageously, component 1 comprises, underneath this surface layer 2, a material chosen to provide very good adhesion of boric acid. In particular, component 1 comprises, underneath surface layer 2, a substrate which either consists of silicon oxide SiO₂ or aluminium oxide Al₂O₃, or is coated with an intermediate layer 3 consisting of silicon oxide SiO₂ or aluminium oxide Al₂O₃ or DLC, or suchlike.

A very thin native oxide spontaneously forms on the silicon. This may suffice as the adhesion layer. It is, however, preferable to thermally oxidise the silicon in order to obtain a controlled oxide layer. The same applies to the alumina Al₂O₃.

The substrate of component 1 may be made in various manners, in particular, but not limited to:
a substrate made of silicon or silicon oxide or CVD diamond or derived from a microfabrication material, either by a LIGA or similar type of additive method, or from a blank transformed via a DRIE or electroerosion or similar type of micromachining method, or resulting from the implementation of a MEMS type method.
a ceramic substrate,
a substrate made of steel or copper alloy, CuBe, nickel or nickel compound, NiP, or a similar alloy commonly used in watchmaking,
a substrate made of noble metal, gold, platinum, or silver,
a substrate made of plastic material.

More particularly, the invention very advantageously applies to a component 1 which is an escapement mechanism component, taken from among an escape wheel, a pallet lever, a balance, a guard pin, an impulse pin, a pallet stone, a banking pin, a roller, a detent pin, a locking stone, a detent, a fork, a pin.

The invention also concerns a timepiece escapement mechanism 10 including at least one such component 1.

More particularly, this escapement mechanism 10 comprises one such component 1, which is an escape wheel made of silicon oxide or a mixture of silicon and silicon oxide SiO₂. Typically, in an advantageous embodiment, component 1 is made of silicon by DRIE, and then thermally oxidised. The microfabrication of components made of silica or quartz (crystalline or amorphous SiO₂) is not yet completely mastered at present. The escape wheel is coated with a boric acid surface layer 2, and is arranged to cooperate with other components 1 which are ruby pallet stones, each coated with such a boric acid surface layer 2.

The invention also concerns a timepiece movement 100 including at least one such escapement mechanism 10.

The invention also concerns a watch 1000 including at least one movement 100 of this type.

The invention also concerns a method for coating a timepiece component 1 with a self-lubricating surface layer 2.

To create this surface layer 2, the method comprises the following steps:
dissolving, at ambient temperature, boric acid H₃BO₃ granules or powder in a solvent chosen from among water, isopropanol, propanol, methanol, methyl propanol, glycol ethylene, glycerol, acetone, or similar, in a proportion of 0.01% to 1.0% by mass, typically close to 0.15% by mass. In the case of water, it is possible to facilitate dissolution by raising the temperature of the water,
mixing and agitating the solution, for example, but not limited to, with the use of ultrasound, which facilitates dissolution,
dipping the component 1 to be coated in said solution, or spraying component 1 with the solution in droplets, by aerosol or in a targeted manner (i.e. only on the functional areas of the component by means of piezo or similar injectors),
in the dipping alternative, removing the component from the solution,
allowing the liquid phase to evaporate, with the surface forming surface layer 2 kept away from any foreign bodies, until evaporation is complete.

More particularly, until the desired layer thickness is obtained, comprised between 10 nanometres and 10 micrometres, repeating the steps consisting in:
dipping or spraying component 1,
in the case of dipping, removing component 1 from the solution,
allowing the liquid phase to evaporate, with the surface forming surface layer 2 kept away from any foreign bodies, until evaporation is complete.

More particularly, these steps are repeated to obtain a thickness comprised between 50 nanometres and 1 micrometre.

The thickness of the boric acid layer H₃BO₃ may also be controlled by the concentration of the solution.

The thickness therefore also depends on the concentration of the solution. Repeating the steps make it possible to increase the thickness, given that the dissolution of the boric acid already formed is relatively slow.

Preferably, this method is applied to the coating of a component 1 of a timepiece escapement mechanism, emitting or subjected to more than one impulse per second, chosen from among an escape wheel, a pallet lever, a balance, a guard pin, an impulse pin, a pallet stone, a banking pin, a roller, a detent pin, a locking stone, a detent, a fork, a pin.

Thus, in this preferred application, the invention consists in coating at least one of the components of the escapement, typically the wheel and/or the pallet stones, with boric acid applied in liquid solution, the liquid being then evaporated to obtain pure boric acid in the solid state at the surface (the melting point of boric acid H₃BO₃=171° C.). Typically, the thickness of the boric acid layer is comprised between 50 nanometres and 1 micrometre. In the most modern escapement mechanisms, the components to be coated with boric acid are typically made of silicon, silicon and silicon oxide, metals or ceramics. These may have a rough or porous surface to promote adhesion.

The typical concentration of the solution is calculated so as to coat the components with a thin layer, more particularly on the order of 100 nm, of solid boric acid. The solubility of H₃BO₃ at ambient temperature is, in the solvent liquids proposed above, higher than the recommended proportion, it is not generally necessary to heat the liquids. However, heating may facilitate dissolution, especially in the case of water which is not inflammable.

To facilitate dissolution, H₃BO₃ powder is advantageously mixed with a solvent and agitated, and ultrasound may also be used.

The component to be coated is dipped in the solution, or sprayed, then removed and left to dry, so as to prevent any contact with the functional parts, for example deposited on blotting paper. A light gas flow may be used to accelerate evaporation of the liquid.

In its final state, component 1 is coated with the desired surface layer 2.

If component 1 is made to have a mirror polished surface prior to coating, interference fringes are visible. The small thickness of deposited boric acid, typically around 50 nm to 100 nm, do not result in a marked change in colour.

For verification, passing a sharp object over the surface may leave a trace indicating the presence of the layer.

Naturally, XRD or Raman analysis can identify with certainty the presence of the H₃BO₃ layer. It is to be noted that, since the deposited surface layer 2 is barely visible, the whole of component 1 may be coated, without causing any mechanical or aesthetic inconvenience.

In short, the invention permits the non-lubricated operation of a timepiece escapement, to reduce maintenance and to allow for high oscillation frequencies.

What is claimed:

1. A timepiece component comprising at least one self-lubricating surface layer, wherein said surface layer is a dry layer consisting entirely of boric acid H₃BO₃ and has a thickness comprised between 50 nanometres and 1 micrometre.

2. The component according to claim 1, wherein said component comprises, underneath said surface layer, a substrate formed of silicon oxide SiO₂ or aluminium oxide Al₂O₃, or which is coated with an intermediate layer formed of silicon oxide SiO₂ or aluminium oxide Al₂O₃.

3. The component according to claim 1, wherein said component comprises, underneath said surface layer, a substrate made of silicon or silicon oxide or CVD diamond or another microfabrication material.

4. The component according to claim 1, wherein said component comprises, underneath said surface layer, a ceramic substrate.

5. The component according to claim 1, wherein said component comprises, underneath said surface layer, a substrate made of steel or copper alloy or nickel or nickel compound.

6. The component according to claim 1, wherein said component comprises, underneath said surface layer, a substrate made of plastic material.

7. The component according to claim 1, wherein said component is an escapement mechanism component, from among an escape wheel, a pallet lever, a balance, a guard pin, an impulse pin, a pallet stone, a banking pin, a roller, a detent pin, a locking stone, a detent, a fork, a pin.

8. A timepiece escapement mechanism including at least one component according to claim 7.

9. The escapement mechanism according to claim 8, wherein the mechanism comprises a said component which is an escape wheel made of silicon oxide or a mixture of silicon and silicon oxide SiO₂, coated with a said boric acid surface layer, which is arranged to cooperate with other said components which are ruby pallet stones each coated with a said boric acid surface layer.

10. A timepiece movement including at least one escapement mechanism according to claim 8.

11. A watch including at least one movement according to claim 10.

12. A method for coating a timepiece component with a self-lubricating surface layer wherein, to produce said layer, the method includes the following steps:
dissolving, at ambient temperature, boric acid H₃BO₃ granules or powder in a solvent chosen from among water, isopropanol, propanol, methanol, methyl propanol, glycol ethylene, glycerol, acetone, in a proportion of 0.01% to 1.0% by mass,
mixing and agitating the solution,
dipping said component to be coated in said solution, or spraying said component with said solution,
in the case of dipping, removing said component from said solution,
allowing the liquid phase to evaporate, with the surface forming said surface layer kept away from any foreign bodies, until evaporation is complete.

13. The method according to claim 12, wherein said steps consisting in:
dipping said component to be coated in said solution, or spraying said component with said solution,
in the case of dipping, removing said component from said solution,
allowing the liquid phase to evaporate, with the surface forming said surface layer kept away from any foreign bodies, until evaporation is complete, are repeated until the desired layer thickness is obtained, comprised between 10 nanometres and 10 micrometres.

14. The method according to claim 13, wherein said steps are repeated until the desired layer thickness is obtained, comprised between 50 nanometres and 1 micrometre.

15. An application of the method according to claim 12 to the coating of a component of a timepiece escapement mechanism, emitting or subjected to more than one impulse per second, chosen from among an escape wheel, a pallet lever, a balance, a guard pin, an impulse pin, a pallet stone, a banking pin, a roller, a detent pin, a locking stone, a detent, a fork, a pin.
